(19) United States
(12) Patent Application Publication
(10) Pub. No.: US 2008/0204580 A1
(43) Pub. Date: Aug. 28, 2008

(54) Method, apparatus and system providing imaging device with color filter array

(75) Inventor: Richard D. Holscher, Boise, ID (US)

Correspondence Address: DICKSTEIN SHAPIRO LLP, 1825 EYE STREET, NW, WASHINGTON, DC, 20006, US

(73) Assignee: MICRON TECHNOLOGY, INC., Bosie, ID (US)

(21) Appl. No.: 11/711,742

(22) Filed: Feb. 28, 2007

(51) Int. Cl. H04N 3/14

(52) U.S. Cl. 348/273; 348/E03.011

(57) ABSTRACT

A method and apparatus that provide a color filter array for use in an imaging device and/or system. The color filter array contains a stopping layer located at least on selected color filters. The stopping layer allows a planarization process step, such as a chemical mechanical planarization process step, to be carried out during the formation of the color filter array. The color filter array so formed can have a planarized surface thereon so that microlenses and/or passivation and oxide layer(s) can be directly formed on such planarized surface of the color filter array.

### FIELD OF THE INVENTION

Embodiments of the invention are related to a method, apparatus and system providing an imaging device with a color filter array.

### BACKGROUND OF THE INVENTION

Solid state image sensors, also known as imagers, have commonly been used in various photo-imaging applications. For example, current applications of solid state image sensors include cameras, camera mobile telephones, video telephones, computer input devices, scanners, machine vision systems, vehicle navigation systems, surveillance systems, auto focus systems, star trackers, motion detector systems, and image stabilization systems among others.

Image sensors, when used with appropriate imaging circuits, can capture, process, store, and display images for various purposes. For example, image sensors are typically formed with an array of pixels each containing a photosensor, such as a photogate, phototransistor, photoconductor, or photodiode. The photosensor in each pixel absorbs incident radiation of a particular wavelength (e.g., optical photons or x-rays) and produces an electrical signal corresponding to the intensity of light impinging on that pixel when an optical image is focused on the pixel array. For example, the magnitude of the electrical signal produced by each pixel can be proportional to the amount of incident light captured. The electrical signals from all the pixels are then processed to provide information about the captured optical image for storage, printing, display, or other uses.

There are a number of different types of semiconductor-based image sensors, including charge coupled devices (CCDs), photodiode arrays, charge injection devices (CIDs), hybrid focal plane arrays, and complementary metal oxide semiconductor (CMOS) image sensors. Examples of CMOS image sensors, processing steps thereof, and detailed descriptions of the functions of various CMOS elements of a CMOS image sensor are described, for example, in U.S. Pat. No. 6,140,630, U.S. Pat. No. 6,376,868, U.S. Pat. No. 6,310,366, U.S. Pat. No. 6,326,652, U.S. Pat. No. 6,204,524, and U.S. Pat. No. 6,333,205, each of which is assigned to Micron Technology, Inc. The disclosures of each of the forgoing patents are hereby incorporated by reference in their entirety.

To capture a color image, a color filter array (CFA) is typically used in the image sensor to separate different color photons in incident light. For example, a color filter array having a Bayer filter pattern can be used and placed in front of the pixel array to obtain the color information of the optical image. In a Bayer filter pattern CFA, the color filters are quartet-ordered with successive rows that alternate red and green filters, then green and blue filters. Each of the color filters is sensitive to one color and allows photons of that color to pass therethrough and reach the corresponding photosensor. The photosensor in each pixel thereby detects and measures only the light of the color associated with the filter provided within that pixel. There are various other color filter arrays formed with alternative filter patterns, such as a CYGM (cyan, yellow, green, magenta) filter pattern, a CKMY (cyan, black, magenta, yellow) filter pattern, an RGBE (red, green blue, emerald) filter pattern, and other patterns having red, green, and blue filters and another color filter arranged between green and blue filters, and others.

Color filter arrays can have a stepped or otherwise unleveled finishing surface due to the separate manufacturing process steps employed to form the different color filters. For example, in a color filter array containing red, green, and blue filters, the green filters can be formed before forming the red and blue filters. As a result, the topography of the resulting color filter array is unfit for use as a consistently flat base on which microlenses or oxide and/or passivation layer(s) can be directly formed.

Accordingly, it is desirable to provide an improved structure for a color filter array, an imaging device, and/or system that overcomes or at least reduces the effects of the above discussed deficiencies. It is also desirable to provide a method of fabricating a color filter array, an imaging device, and/or system exhibiting these improvements.

### BRIEF DESCRIPTION OF THE DRAWINGS

FIG. 1 illustrates a partial cross-sectional view of a pixel array containing a color filter array constructed in accordance with a first embodiment.

FIG. 2 illustrates a partial cross-sectional view of a pixel array containing a color filter array constructed in accordance with a second embodiment.

FIGS. 3A to 3G illustrate one embodiment of a method of fabricating an imaging device containing the color filter array as shown in FIG. 1.

FIGS. 4A to 4D illustrate another embodiment of a method of fabricating an imaging device containing the color filter array as shown in FIG. 2.

FIG. 5 is a block diagram of an imaging device constructed in accordance with one of the embodiments.

FIG. 6 is an illustration of an imaging system comprising the imaging device formed in accordance with one of the embodiments.

### DETAILED DESCRIPTION OF THE INVENTION

In the following detailed description, reference is made to the accompanying drawings, which form a part hereof and show by way of illustration specific embodiments and examples in which the invention may be practiced. These embodiments and examples are described in sufficient detail to enable one skilled in the art to practice them. It is to be understood that other embodiments and examples may be utilized, and that structural, logical, and electrical changes and variations may be made. Moreover, the progression of processing steps is described as an example; the sequence of steps is not limited to that set forth herein and may be changed, with the exception of steps necessarily occurring in a certain order.

The term “substrate” used herein may be any supporting structure including, but not limited to, a semiconductor substrate having a surface on which devices can be fabricated. A semiconductor substrate should be understood to include silicon, silicon-on-insulator (SOI), silicon-on-sapphire (SOS), doped and undoped semiconductors, epitaxial layers of silicon supported by a base semiconductor foundation, and other semiconductor structures, including those made of semiconductors other than silicon. When reference is made to a semiconductor substrate in the following description, previous process steps may have been utilized to form regions or junctions in or over the base semiconductor or foundation.

The term “pixel” or “pixel cell” as used herein, refers to a photo-element unit cell containing a photosensor for converting photons to an electrical signal as may be employed by an imaging device. The pixel cells illustrated herein in the embodiments can be CMOS four-transistor (4-T) pixel cells, or have more or less than four transistors. However, the embodiments disclosed herein may be employed in other types of solid state image sensors other than CMOS image sensors, e.g., CCD and others, where a different pixel and readout architecture may be used.

Various embodiments will now be described with reference to the drawing figures, in which similar components and elements are designated with same reference numerals and redundant description is omitted. Although the embodiments are described in relation to use with a CMOS imaging device, the embodiments are not so limited and, as a result, have applicability to other solid state imaging devices.

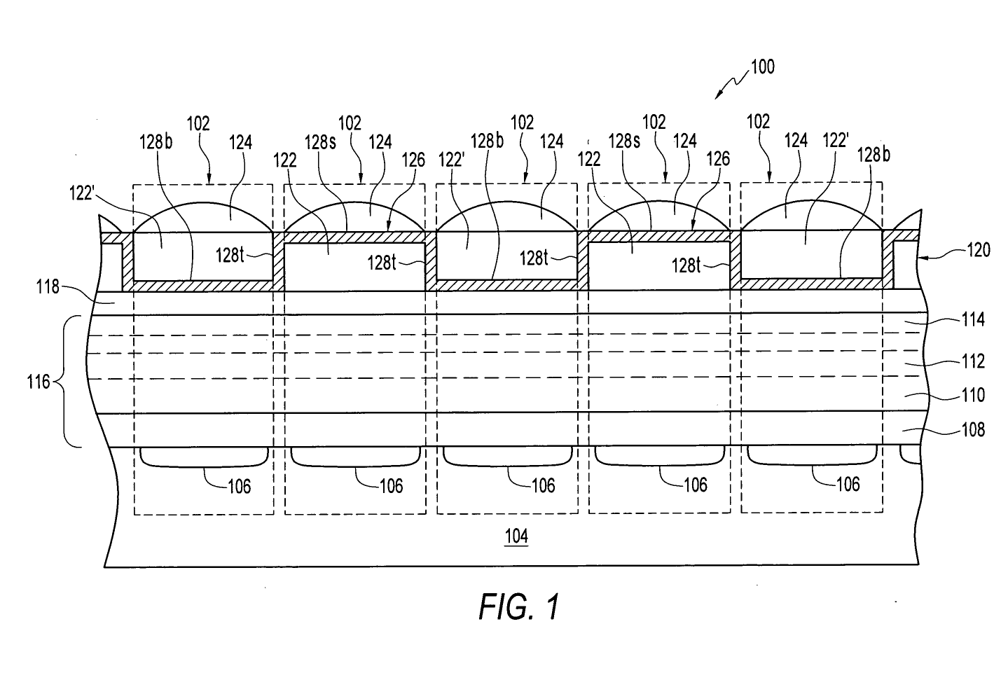

FIG. 1 illustrates a partial cross-sectional view of a pixel array 100 constructed in accordance with a first embodiment. The pixel array 100 can contain an array of pixel cells 102 formed over a semiconductor substrate 104. Each pixel cell 102 can include a photosensitive region 106 formed in association with the substrate 104. A plurality of conventional layers, illustrated as interlayer dielectric layers 108, 110, 112, and 114 (collectively referred to as layers 116), with associated metallization patterns can be formed over the substrate 104. A passivation layer 118 can be provided over the collective dielectric layers 116, on which a color filter array 120 can be formed as described below. The passivation layer 118 can be formed, for example, of one or more of phospho-silicate-glass (PSG), silicon nitride, nitride, and oxynitride. Although only one passivation layer 118 is shown, more than one passivation layer can be used. Those skilled in the art will appreciate that the substrate 104, the photosensitive regions 106, the interlayer dielectric layers 116, the passivation layer 118, and associated metallization patterns can be formed by any of various known methods.

The color filter array 120 is formed over the passivation layer 118 for capturing different color components in incident light. The color filter array 120 is formed of a plurality of color filters 122, 122′, each of which is provided within a pixel cell 102 and positioned over a corresponding photosensitive region 106 and below a corresponding microlens 124. As those skilled in the art will appreciate, each color filter 122, 122′ is formed to be sensitive to a specific wavelength (band), allowing light of that wavelength (band) to pass through and reach the corresponding photosensitive region 106.

The various color filters 122, 122′ in the color filter array 120 can be formed to be sensitive either to the same wavelength or to different wavelengths of light. For example, all of the color filters 122, 122′ can be formed to be the same as one another, such as for allowing infrared light to pass therethrough. The pixel array 100 so formed can be used to capture infrared light images. In the alternative, the color filter array 120 can be formed so that some filters (e.g., color filters 122) pass only one component in the incident light, while other filters (e.g., color filters 122′) allow another light component to pass through, so that the resulting pixel array 100 can capture optical images with different wavelengths. For example, the color filter array 120 can have red, green, and blue filters arranged in a predetermined mosaic sequential pattern, such as a Bayer pattern. Those skilled in the art will appreciate that filters of other colors or patterns may also be used to capture color images.

The pixel array 100 further comprises a stopping layer 126, at least a part of which is formed over the color filter array 120. In the embodiment shown in FIG. 1, the stopping later 126 can comprise a plurality of stopping sections 128s located on at least color filters 122. For example, in a color filter array 120 of a Bayer pattern, the stopping sections 128s can be provided and formed on the green filters. Those skilled in the art will appreciate that the stopping sections 128s can also be formed on filters of another color.

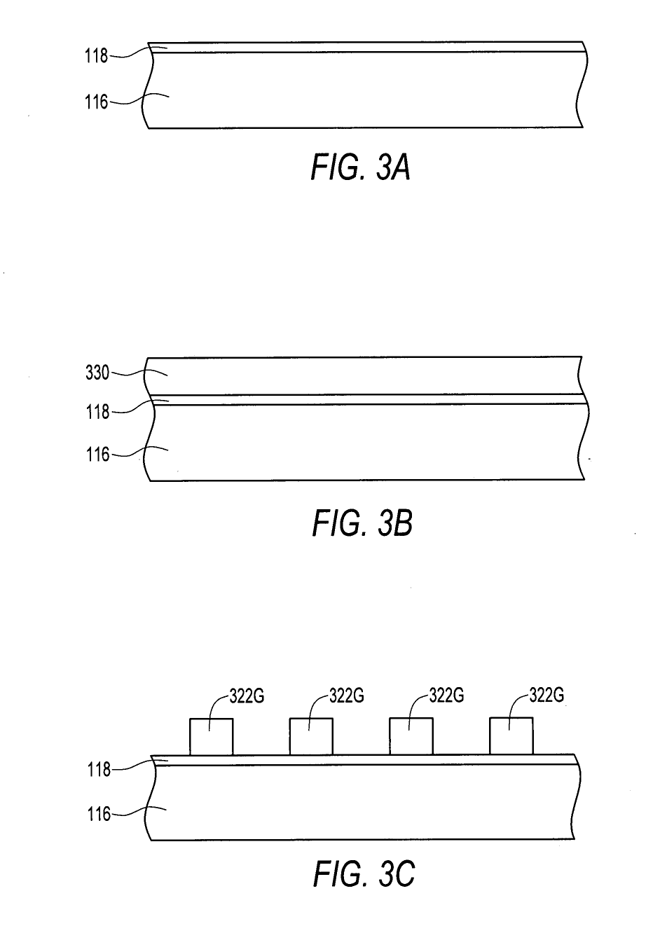

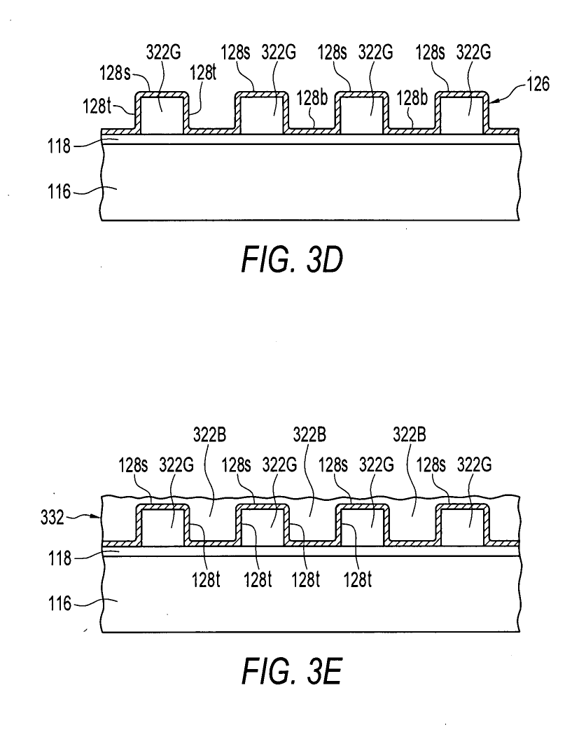

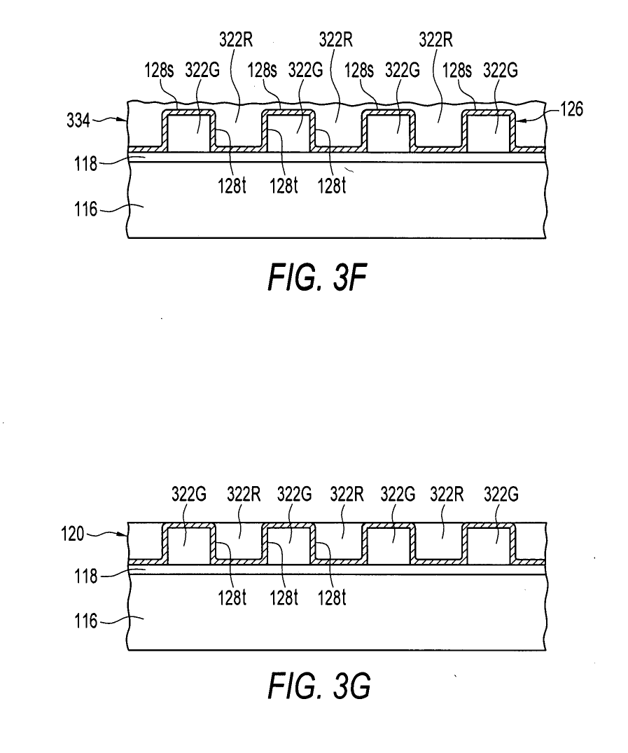

The stopping layer 126 and/or the stopping sections 128s can facilitate the formation of the pixel array 100, such as by providing a planar surface in the color filter array 120. For example, the stopping sections 128s allow a planarization process step, such as a chemical mechanical planarization (CMP) process step, to be carried out during the formation of the color filter array 120. In one example, the stopping sections 128s can be formed to be more resistant to a CMP process step than color filters 122′. When the a CMP process is carried out to remove excessive materials used to form color filters 122′, the stopping sections 128s can act as a reference point to stop the progress of the process (e.g., the completion of planarization of color filters 122′). For example, when the color filters 122′ have been reduced to the same level as that of the stopping sections 128s (see, e.g., FIG. 3G), further reduction stops to avoid unnecessary performance of the CMP process step. The color filter array 120 so formed can have a planar finishing surface, over which microlenses 124 and/or passivation and oxide layer(s) can be directly formed.

Additionally or alternatively, the stopping sections 128s are capable of maintaining and protecting the boundaries of the selected color filters 122 during the manufacturing process, including various steps such as photolithography and planarization processes. For example, after the stopping sections 128s are formed on the selected color filters 122 (e.g., green filters), the stopping sections 128s remain in position throughout the subsequent process steps that form the remaining color filters 122′. As each of the stopping sections 128s at least partially shields the underlying color filter 122 from being exposed to abrasion or corrosion during the planarization process, the stopping sections 128s can effectively maintain the integrity of the respective underlying color filters 122.

In addition, the stopping sections 128s can help to more accurately define the boundaries of adjacent color filters 122′. For example, when the stopping sections 128s are formed on the green filters in a Bayer patterned color filter array 120, each of the remaining color filters 122′ (i.e., red and blue filters) is adjacent to four stopping sections 128s, which can collectively define the boundaries of each red or blue filter. Therefore, the stopping sections 128s are capable of maintaining the integrity of all color filters 122, 122′ in the color filter array 120.

As is shown in FIG. 1, the stopping layer 126 may also comprise one or more transverse sections 128t, which extend transversely with respect to the stopping sections 128s. The transverse sections 128t each can be formed to surround at least a portion of a side wall of a selected color filter 122 or otherwise located between such selected color filter 122 and its adjacent color filter 122′. In one example, the transverse sections 128t are formed to be substantially level with the upper surfaces of the stopping sections 128s and the color filters 122′. In a desired embodiment, the transverse sections 128t extend between the upper surface of the stopping sections 128s and the passivation layer 118 to substantially cover the entire side walls of the selected color filters 122.

The transverse sections 128t can be formed as a continuous or integral portion of the stopping layer 126. In one example, each stopping section 128s and its adjacent transverse sections 128t can be continuously formed and conformed to the underlying selected color filter 122. In another example, the transverse sections 128t each extend continuously from a stopping section 128s and join to a lower section 128b, which is formed under an adjacent color filter 122′. As is shown in FIG. 1, the lower sections 128b can also be continuously formed with the transverse sections 128t as an integral portion of the stopping layer 126. For example, the stopping sections 128s, the transverse sections 128t, and the lower sections 128b can form a continuous stopping layer 126, which extends throughout the color filter array 120 or the entire wafer (not shown).

The transverse sections 128t can help to keep the stopping sections 128s in position. For example, when the transverse sections 128t are formed continuously from or integrally with the stopping sections 128s, the stopping sections 128s are held against the selected color filters 122 by the transverse sections 128t, which are held between two adjacent color filters 122, 122′. Accordingly, the stopping sections 128s are less likely to be separated or stripped from the underlying color filter 122, such as during a planarization process as will be described below. In another example, the transverse sections 128t can be assisted by the lower sections 128b to secure the stopping sections 128s on the selected color filters 122.

Additionally or alternatively, the transverse sections 128t, located between different filters 122, 122′, can prevent color pigments in one color filter from migrating into an adjacent filter of a different color. In addition, the transverse sections 128t can define and protect the boundaries of each selected color filter 122 and/or other color filters 122′ in the color filter array 120. Accordingly, the transverse sections 128t can afford separate protection to the color filters 122, 122′ in addition to that provided by the stopping sections 128s in the stopping layer 126.

The stopping layer 126 can be formed of any of various transparent materials. For example, the stopping layer 126 can be formed of a material that is less likely to be removed than the photoresist materials of the color filters 122′ during a planarization process step, such as a chemical mechanical planarization (CMP) process. In one embodiment, the stopping layer material can have a lower CMP rate than that of the materials forming the color filters 122′.

Additionally or alternatively, the stopping layer materials can be so determined that the formation of the stopping layer 126 will not adversely affect the selected color filters 122 or the other color filters 122′. In other words, the stopping layer 126 is formed of materials that are compatible with various photoresist materials used to form the various color filters 122, 122′. For example, the stopping layer materials may be those that can be formed at a temperature without inducing adverse effect to the selected color filters 122 formed prior to the stopping layer 126. In one example where color filters 122 are cured at a temperature of about 240° C. before the formation of the stopping layer 126, suitable materials for the stopping layer 126 may be those that can be formed at a temperature of about 240° C. or less.

Exemplary materials for the stopping layer 126 may include, but are not limited to, oxide materials, silicon nitride materials, and mixture of oxide and nitride materials (e.g., silicon oxynitride, such as a dielectric antireflective coating). In a desired embodiment, the stopping layer 126 is formed of an oxide material. Those skilled in the art will appreciate that various other transparent materials can also be used to form the stopping layer 126.

The stopping layer 126 can be formed to have various thicknesses. For example, the stopping layer 126 can have a thickness of about 100 Angstroms or more. The thickness of the stopping layer 126 can be determined depending on a number of factors, such as the size of the pixel cell 102. In an example where the pixel cell 102 has a size of about 6 μm to about 10 μm, the stopping layer 126 can have a thickness of up to about 1000 Angstroms. In another example where the pixel cell 102 has a size of about 3 μm, the stopping layer 126 can have a thickness of less than about 300 Angstroms. It is desired that the stopping layer 126 has a thickness formed in the range from about 100 Angstroms to about 300 Angstroms.

The transverse sections 128t of the stopping layer 126 can have any of various lateral thicknesses without interfering with the function and performance of the color filters 122, 122′. In one example, the transverse sections 128t can have a lateral thickness substantially the same as the thickness of the remaining portions of the stopping layer 126. For example, the transverse sections 128t can have a lateral thickness of in the range from about 100 Angstrom to about 300 Angstroms. In another example, the transverse sections 128t can have a smaller lateral thickness than the thickness of the stopping sections 128s, allowing maximizing the size of color filters 122, 122′ in the pixel cells 102.

The lower sections 128b of the stopping layer 126 can have any of various thicknesses without interfering with the function and performance of color filters 122′. In one example, the lower sections 128b can have a thickness similar to that of the transverse sections 128t. For example, the thickness of the lower sections 128b can be in the range from about 100 Angstroms to about 300 Angstroms. In another example, the lower sections 128b can be formed to be thinner than the stopping sections 128s but thicker than the transverse sections 128t. Those skilled in the art will appreciate that the stopping layer 126, stopping sections 128s, transverse sections 128t, and lower sections 128b can be formed of various other thicknesses and/or materials.

The stopping layer 126 so formed can improve the structure and performance of the color filter array 120. As is describe above, the stopping layer 126 can facilitate the formation of the pixel array 100, such as by providing a planar surface in the color filter array 120. Additionally or alternatively, the stopping layer 126 can protect the upper surfaces and/or side walls of the selected color filters 122 as well as define the boundaries of adjacent color filters 122′ during the fabrication process of the color filter array 120. The stopping layer 126 can also prevent color pigments contained in one color filter from mixing into adjacent color filters of a different color, thereby improving color separation. The stopping layer 126 can thus maintain the pattern integrity of the color filter array 120.

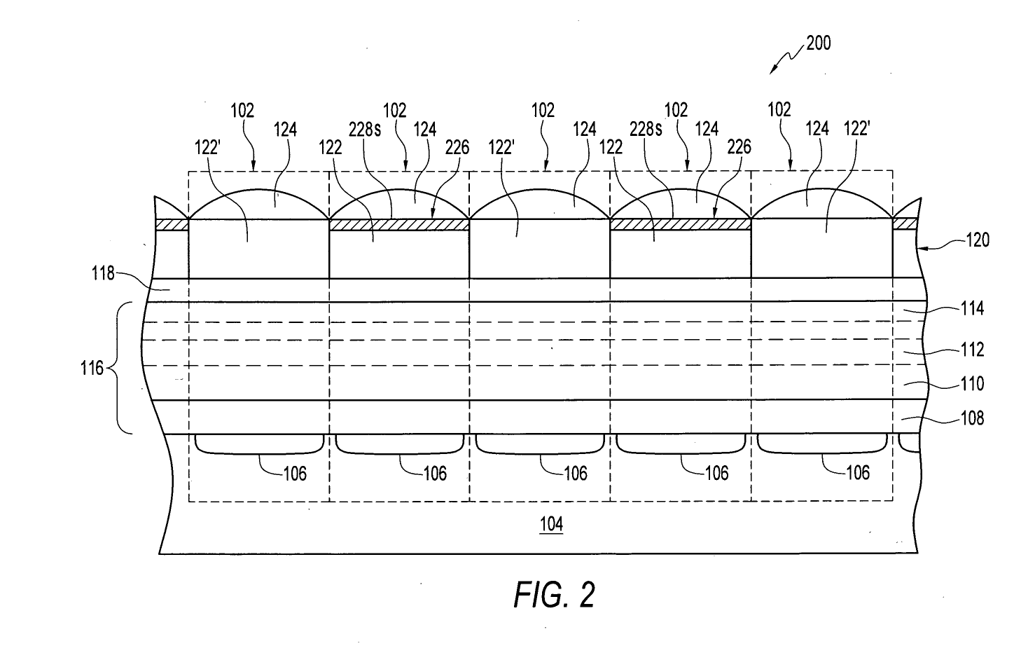

FIG. 2 shows another embodiment of a pixel array 200, in which the stopping layer 226 can be formed with only stopping sections 228s. The stopping sections 228s can be similar to the stopping sections 128s as described above, but the transverse sections 128t or the lower sections 128b shown in FIG. 1 do not exist in this embodiment.

Next, various methods of fabricating pixel arrays 100 and 200 having a color filter array 120 as described above will be described.

FIGS. 3A to 3G illustrate a first embodiment of a method of fabricating a pixel array, such as the pixel array 100 shown in FIG. 1. FIG. 3A shows that a fabricated structure 116 is provided and in which the color filter array 120 (see FIG. 3G) can be formed. The array of photosensitive regions 106 and various dielectric and interconnect metallization layers, which are included within the fabricated structure 116, are not depicted in FIGS. 3A to 3G for purposes of simplification. A passivation layer 118, e.g., a transparent nitride or oxide, is typically formed over the fabricated structure 116 by any method.

As is illustrated in FIG. 3B, a first color filter material layer 330 is formed over the passivation layer 118 by any of various methods. For example, the first color filter material layer 330 can be deposited on the passivation layer 118, and then cured. In one example, the first color filter material layer 330 is deposited over the passivation layer 118 by spin-coating methods. The spin-coating technique provides a simplified fabrication process resulting in a substantially planar material layer with minimal fabricating costs. The first color filter material layer 330 can then be cured at a temperature of about 240° C. Those skilled in the art will appreciate that various other methods can be used to form the first color filter material layer 330.

The first color filter material layer 330 can be made of any of various transparent materials suitable for color filters. In one example, the materials for the first color filter material layer 330 have a coloring suitable to form green filters. The materials forming the first color filter material layer 330 can be either positive or negative photoresist. For example, the material for the first filter material layer 330 is sensitive to i-line radiations. Exemplary materials for the first color filter material layer 330 can include, but not be limited to, zinc selenide (ZnSe), silicon oxide, silicon nitride, silicon oxynitride, silicon-carbon (SiC) (BLOk), tantalum pentoxide (Ta₂O₅), titanium oxide (TiO₂), polymethylmethacrylate, polycarbonate, polyolefin, cellulose acetate butyrate, polystyrene, polyimide, epoxy resin, photosensitive gelatin, acrylate, methacrylate, urethane acrylate, epoxy acrylate, or polyester acrylate.

FIG. 3C illustrates that a plurality of first color filters 322G are formed by any of various known methods, such as a standard photolithographic process. For example, a photomask (not shown) having a predetermined pattern corresponding to the selected color filters 122 (see, e.g., FIG. 1) can be employed to pattern the first color filter material layer 330, such as through a conventional exposure process step. In one example, the pattern of the photomask can correspond to the layout of green filters in a Bayer pattern. The light source used in the exposure process step can have any wavelength providing the required lithographic resolution. For example, a light source (not shown), such as an i-line light source (e.g., 365 nanometers), shines on the photomask and exposes a portion of the first color filter material layer 330, which is sensitive to i-line radiations. The unwanted portions on the first color filter material layer 330 can then be removed by any of various conventional methods, such as a developing process, to form the first color filters 322G.

As is illustrated in FIG. 3D, a stopping layer 126 is formed over the first color filters 322G by any of various methods known in the art. For example, various suitable conformal techniques can be employed, including one or more spin-on techniques or any other techniques for conformal material deposition, such as chemical vapor deposition (CVD) or physical vapor deposition (PVD). In one example, a plasma enhanced chemical vapor deposition (PECVD) process is used. Additionally or alternatively, the stopping layer 126 can be formed at such a temperature that the formation of the stopping layer 126 will not adversely affect the underlying first color filters 322G. For example, the stopping layer 126 is formed over the first color filters 322G at a temperature of about 240° C. or less. In one example, the stopping layer 126 is formed at room temperature. The stopping layer 126 can be formed with any of the materials described above, such as an oxide material.

In one embodiment as is shown in FIG. 3D, the stopping layer 126 can be in the form of a continuous layer. For example, the stopping layer 126 can have a plurality of stopping sections 128s located on the first color filters 322G, transverse sections 128t covering the side walls of the first color filters 322G, and lower sections 128b located on the passivation layer 118 between the first color filters 322G. In one example, the continuous stopping layer 126 can have one uniform thickness. For example, the thickness of the stopping layer 126 can be about 100 Angstroms or more, or in the range from about 100 Angstroms to about 300 Angstroms. In another example, the stopping sections 128s, the transverse sections 128t, and the lower sections 128b can be formed to have different thicknesses. For example, the transverse sections 128t and/or the lower sections 128b can have a lesser thickness than that of the stopping sections 128s. Those skilled in the art will appreciate that the thickness of the transverse sections 128t and/or lower sections 128b can be adjusted in the formation process and/or controlled to the extent that they will not adversely affect the first color filters 322G and/or additional color filters 322B, 322R (see FIGS. 3E and 3F).

The formation of additional color filters 322B, 322R will be described in connection with FIGS. 3E and 3F, which are cross-sections of different pixel rows in pixel array 100 (see, FIG. 1). FIG. 3E shows one row of alternating first and second color filters 322G, 322B, such as the green and blue filters in a Bayer pattern color filter array. FIG. 3F shows one row of alternating first and third color filters 322G, 322R, such as the green and red filters in a Bayer pattern color filter array.

As is shown in FIG. 3E, a second color filter material layer 332 is formed over the stopping layer 126 by any of various methods. For example, the second color filter material layer 332 is deposited between the first color filters 322G and over the stopping sections 128s, such as by spin-coating methods. The second color filter material layer 332 can be formed of any suitable material, similar to but different in color from that of the first color filter material layer 330. For example, the second color filter material layer 332 can comprise either a blue or red filter material for forming blue or red filters. In an example of a Bayer filter pattern color filter array 120 (see, e.g., FIG. 3G), the second color filter material layer 332 comprises a blue filter material and is next provided to form blue filters. The second color filter material layer 332 can then be cured.

The second color filters 322B can be formed from the second color filter material layer 332 by any of various methods. For example, a standard photolithography process can be used to pattern and develop the second color filter material layer 332, such as in a similar manner as described above in connection with the formation of the first color filters 322G. The unwanted portions on and/or unexposed color pigment in the second color filter material layer 332 can be removed by a developing process. In one example, the second color filter material layer 332 is selectively etched to selectively remove the second color filter material layer 332 from areas where the third color filters 322R (see FIG. 3F) are to be formed, while the second color filters 322B are protected. In another example, the second color filter material layer 332 can be selectively etched while the areas of both the previously formed first color filters 322G and the desired second color filters 322B (e.g., green and blue filters in a Bayer pattern CFA) are protected.

As FIG. 3E shows, the second color filters 322B are formed and are each separated from an adjacent first color filter 322G by a transverse section 128t. In one example of a Bayer pattern color filter array 120, the second color filters 322B can be blue filters.

Similar to the above described process steps, third color filters 322R can be formed as illustrated in FIG. 3F. For example, a third color filter material layer 334 can be deposited over the passivation layer 118 including areas where the first and second color filters 322G, 322B (not shown in FIG. 3F) are located. The third color filter material layer 334 can be formed of any suitable material, which is similar to but has a different color from those used for the first and second color filter material layers 330 and 332. In an example of a Bayer filter pattern CFA 120 (see, e.g., FIG. 3G), the third color filter material layer 334 comprises a red filter material and is next provided to form red filters. The third color filter material layer 334 can then be patterned and developed to form the third color filters 322R. The above process steps can be repeated until all color filters are formed.

In one example, the last group of color filters can be formed by depositing the color filter material over the passivation layer 18 without the patterning and developing process steps. For example, after forming the green and blue filters in a Bayer pattern color filter array, the red filters can be formed by coating a red filter material in locations where the red filters are to be formed.

Additional process steps can be employed to remove unwanted portions of and/or unexposed color pigment in one or more of the additional color filter material layers 332, 334. In one embodiment, a planarization process step is carried out after the color filter material of the last group of color filters is deposited in place to remove the color filter materials protruding above the stopping sections 128s. For example, a chemical mechanical planarization (CMP) process step can be performed to remove the protrusions and bring the additional color filters 322B (not shown in FIG. 3G), 322R level with the stopping sections 128s, as is shown in FIG. 3G. If desired, the planarization process step can be performed after each additional color filter material layer 332, 334 is deposited in place and cured.

In a desired embodiment, one or more of the stopping sections 128s can be used as a stopping layer in the chemical mechanical planarization (CMP) process step. For example, the friction generated between the stopping sections 128s and the polishing pad (not shown) during the CMP process step differs from that between the protruding additional color filter material layers 332, 334 and the polishing pad. When such additional color filter material layers 332, 334 are planarized to the same level of the stopping sections 128s, the increase in the pressure between the wafer (not shown) and the polishing pad can be used as an indication that the chemical mechanical planarization process is completed. A planar finishing surface can thus be provided on the stopping sections 128s and the additional color filters 322B, 322R in the resulting color filter array 120, as is shown in FIG. 3G.

FIG. 3G shows one row of a color filter array 120, where the first color filters 322G alternate with the third color filters 322R. The color filter array 120 formed according to the above described embodiment can provide a planar upper surface, over which microlenses 124 (see, e.g., FIG. 1) and/or additional passivation or oxide layer(s) (not shown) can be directly formed. Accordingly, there is no need for an additional planar layer on the color filter array 120.

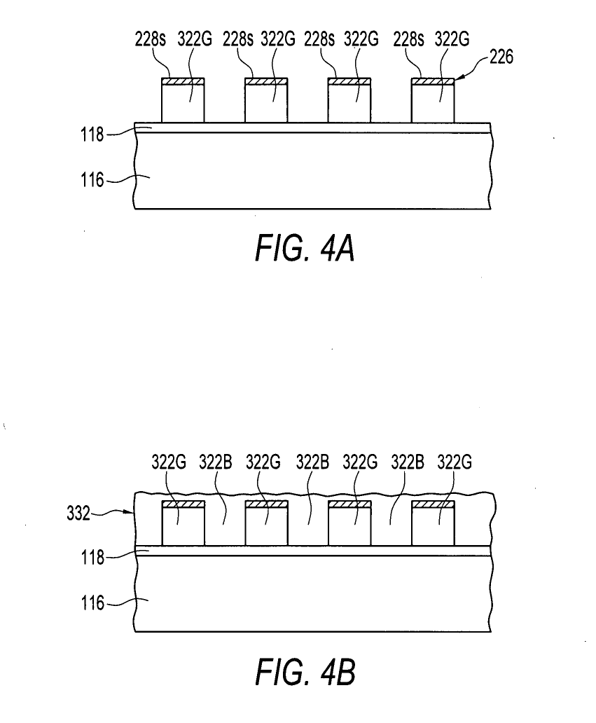

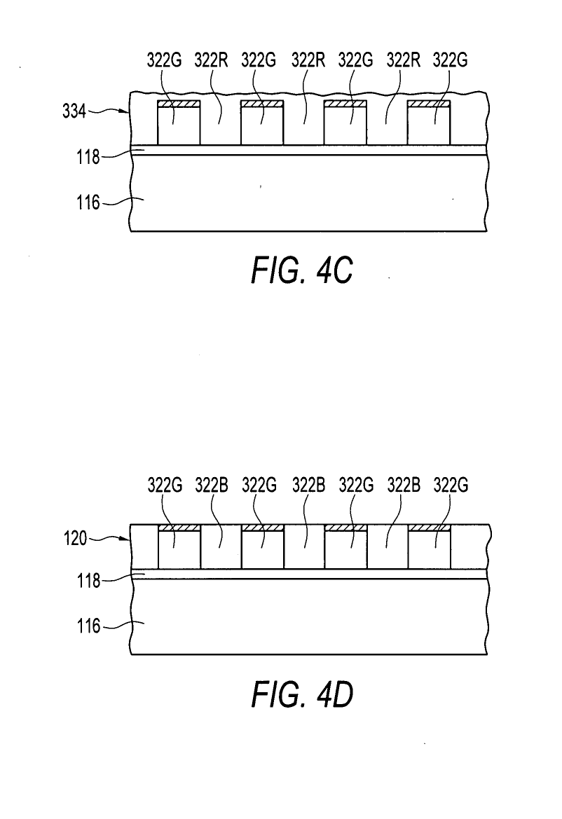

FIGS. 4A to 4D show an alternative embodiment of a method of fabricating a pixel array, such as the pixel array 200 shown in FIG. 2. In this embodiment, the first color filters 322G can be formed by any of various methods described above. As is shown in FIG. 4A, the stopping layer 226 is formed on the first color filters 322G only, without additional portions similar to the transverse sections 128t or the lower sections 128b (shown in FIGS. 3D to 3G). In one example, the stopping sections 228s can be formed by selectively removing unwanted portions of a continuous layer similar to the stopping layer 126 shown in FIG. 3D. For example, a spacer material removal process step can be employed for such purposes, such as through an etching process using a patterned filter layer (not shown). Those skilled in the art will appreciate that the stopping layer 226 can be formed by various other methods known in the art.

As is shown in FIGS. 4B to 4D, the additional color filters 322B, 322R can be formed similarly to those in the prior embodiment. For example, a second color filter material layer 332 can be deposited between the first color filters 322G and patterned and developed to form the second color filters 322B. A planarization process step, such as a chemical mechanical planarization (CMP) process step, can be performed to remove unwanted portions of and/or unexposed color pigment in the second color filter material layer 332. In an alternative embodiment, the planarization process step can be performed after the color filter material of the last group of color filters is deposited in place. During the planarization process, the stopping layer 226 can be used to stop the planarization operation when the color filter material layers 332, 334 become level with the stopping sections 228s. The resulting color filter array 120 can have a planar finishing surface formed collectively by the stopping sections 228s and the additional color filters 322B, 322R.

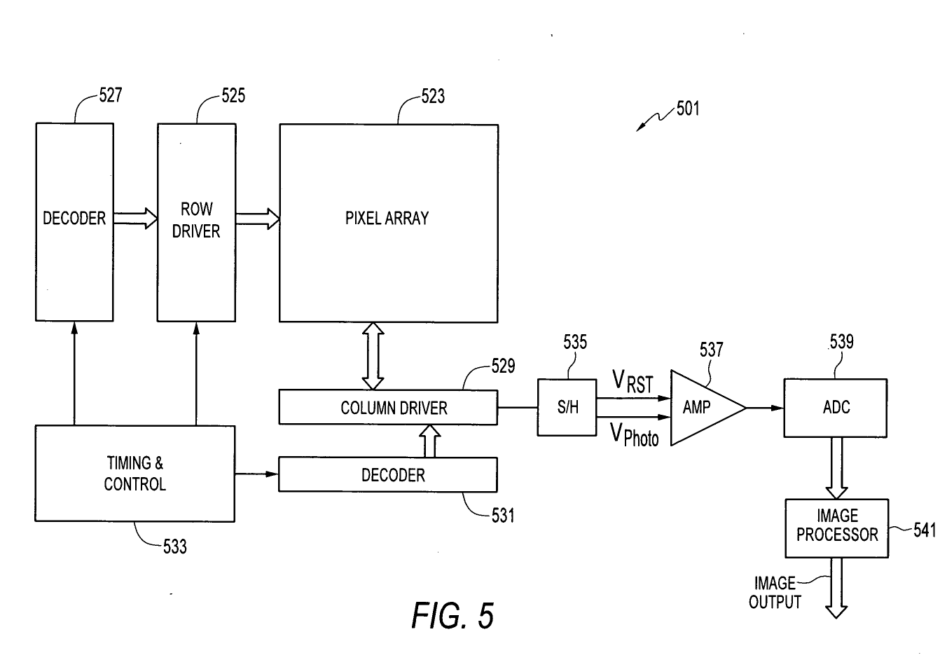

FIG. 5 is a block diagram of an imaging device 501 having a pixel array 523, which is similar to pixel array 100 or 200 formed according to various embodiments described above. The pixel array 523 is formed with pixel cells (see, e.g., FIG. 1) arranged in a predetermined number of columns and rows. The pixel cells in the pixel array 523 may be constructed in accordance with any of the embodiments described above. The pixel array 523 can capture incident radiation from an optical image and convert the captured radiation to electrical signals, such as analog signals.

The electrical signals obtained and generated by the pixel cells in the pixel array 523 can be read out row by row to provide image data of the captured optical image. For example, pixel cells in a row of the pixel array 523 are all selected for read-out at the same time by a row select line, and each pixel cell in a selected column of the row provides a signal representative of received light to a column output line. That is, each column also has a select line, and the pixel cells of each column are selectively read out onto output lines in response to the column select lines. The row select lines in the pixel array 523 are selectively activated by a row driver 525 in response to a row address decoder 527. The column select lines are selectively activated by a column driver 529 in response to a column address decoder 531.

The imaging device 501 can also comprise a timing and controlling circuit 533, which generates one or more read-out control signals to control the operation of the various components in the imaging device 501. For example, the timing and controlling circuit 533 can control the address decoders 527 and 531 in any of various conventional ways to select the appropriate row and column lines for pixel signal read-out.

The electrical signals output from the column output lines typically include a pixel reset signal (V_{RST}) and a pixel image signal (V_{Photo}) for each pixel cell. In an example of a four-transistor CMOS imaging sensor (not shown), the pixel reset signal (V_{RST}) can be obtained from a corresponding floating diffusion region when it is reset by a reset signal RST applied to a corresponding reset transistor, while the pixel image signal (V_{Photo}) is obtained from the floating diffusion region when photo generated charge is transferred to the floating diffusion region. Both the V_{RST} and V_{Photo} signals can be read into a sample and hold circuit (S/H) 535. In one example, a differential signal (V_{RST}−V_{Photo}) can be produced by a differential amplifier (AMP) 537 for each pixel cell. Each pixel cell's differential signal can be digitized by an analog-to-digital converter (ADC) 539, which supplies digitized pixel data as the image data to be output to an image processor 541. Those skilled in the art would appreciate that the imaging device 501 and its various components can be in various other forms and/or operate in various other ways. In addition, the imaging device 501 illustrated, is a CMOS image sensor, but other types of image sensor core may be used.

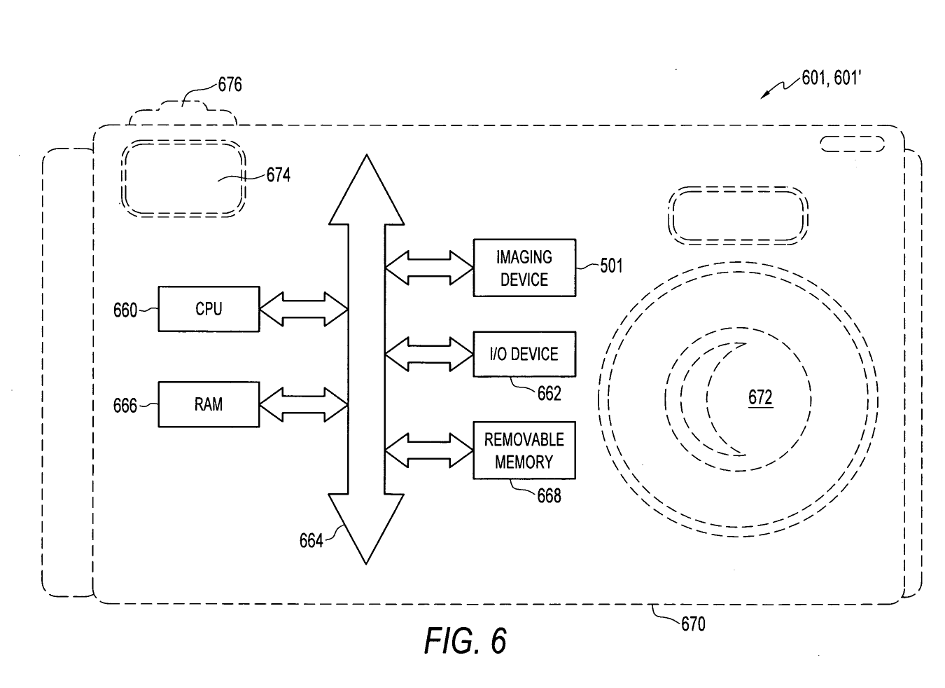

FIG. 6 illustrates a processing system 601 including an imaging device 501. The imaging device 501 may be combined with a processor, such as a CPU, digital signal processor, or microprocessor, with or without memory storage on a single integrated circuit or on a different chip than the processor. In the example as shown in FIG. 6, the processing system 601 can generally comprise a central processing unit (CPU) 660, such as a microprocessor, that communicates with an input/output (I/O) device 662 over a bus 664. The processing system 601 can also comprise random access memory (RAM) 666, and/or can include removable memory 668, such as flash memory, which can communicate with CPU 660 over the bus 664.

The processing system 601 can be any of various systems having digital circuits that could include the imaging device 501. Without being limiting, such a processing system 601 could include a computer system, a digital camera, a scanner, a machine vision, a vehicle navigation, a video telephone system, a camera mobile telephone, a surveillance system, an auto focus system, a star tracker system, a motion detection system, an image stabilization system, and other systems supporting image acquisition. In the example shown in FIG. 6, the processing system 601 is employed in a digital camera 601′, which has a camera body portion 670, a camera lens 672, a view finder 674, and a shutter release button 676. When depressed, the shutter release button 676 operates the imaging device 501 so that light from an image reaches and is captured by the pixel array 100 or 200 (see, FIG. 1 or 2). As those skilled in the art will appreciate, the imaging device 501, the processing system 601, the camera system 601′ and other various components contained therein can also be formed and/or operate in various other ways.

It is again noted that although the above embodiments are described with reference to a CMOS imaging device, they are not limited to CMOS imaging devices and can be used with other solid state imaging device technology (e.g., CCD technology) as well.

It will be appreciated that the various features described herein may be used singly or in any combination thereof. Therefore, the embodiments are not limited to the embodiments specifically described herein. While the foregoing description and drawings represent examples of embodiments, it will be understood that various additions, modifications, and substitutions may be made therein as defined in the accompanying claims. In particular, it will be clear to those skilled in the art that other specific forms, structures, arrangements, proportions, materials can be used without departing from the essential characteristics thereof. The presently disclosed embodiments are therefore to be considered in all respects as illustrative and not restrictive.

What is claimed as new and desired to be protected by Letters Patent of the United States is:

1. A color filter array comprising:
a plurality of color filters formed over an underlying structure; and
a stopping layer formed on at least one first color filter and extending to at least partially cover a side wall of the first color filter.

2. The color filter array of claim 1 further comprising a planarized surface level with the stopping layer.

3. The color filter array of claim 1, wherein the stopping layer comprises:
a plurality of stopping sections formed on a plurality of first color filters; and
a plurality of transverse sections each extending transversely from one of the stopping sections, the transverse sections substantially covering side walls of the plurality of first color filters.

4. The color filter array of claim 3, wherein at least one of the transverse sections extends at least partially between the first color filter and its adjacent color filter.

5. The color filter array of claim 3, wherein the transverse sections entirely cover side walls of each of the first color filters.

6. The color filter array of claim 3, wherein the stopping layer further comprises a plurality of lower sections each extending from one of the transverse sections and located below a second color filter.

7. The color filter array of claim 6, wherein the stopping layer is continuous.

8. The color filter array of claim 6, wherein the stopping layer is an integral layer.

9. The color filter array of claim 1, wherein the stopping layer is formed to be more resistant to a chemical mechanical planarization process than other color filters.

10. The color filter array of claim 1, wherein the stopping layer comprises a material that is more resistant to a planarization process than a material used for second color filters.

11. The color filter array of claim 1, wherein the stopping layer is formed of a material selected from the group consisting of an oxide material, a silicon nitride material, and a mixture thereof.

12. The color filter array of claim 11, wherein the stopping layer is formed of an oxide material.

13. The color filter array of claim 11, wherein the stopping layer is formed of a silicon oxynitride material.

14. The color filter array of claim 11, wherein the stopping layer is a dielectric antireflective coating.

15. The color filter array of claim 1, wherein the stopping layer has a substantially uniform thickness throughout the color filter array.

16. The color filter array of claim 1, wherein the stopping layer has a thickness up to about 1000 Angstroms.

17. The color filter array of claim 1, wherein the stopping layer has a thickness up to about 300 Angstroms.

18. The color filter array of claim 17, wherein the stopping layer has a thickness of about 100 Angstroms or more.

19. The color filter array of claim 17, wherein the stopping layer has a thickness in the range from about 100 Angstroms to about 300 Angstroms.

20. The color filter array of claim 3, wherein the transverse sections have a lesser lateral thickness than the thickness of the stopping sections.

21. An imaging device comprising:
a semiconductor structure; and
a color filter array formed over the semiconductor structure, the color filter array comprising at least one first color filter and a stopping layer formed on the first color filter;
wherein the color filter array comprises a planarized surface level with the stopping layer.

22. The imaging device of claim 21, wherein the stopping layer extends transversely to at least partially cover one or more side walls of the first color filter.

23. The imaging device of claim 21, wherein the stopping layer comprises:
a plurality of stopping sections formed on a plurality of first color filters; and
a plurality of transverse sections each extending transversely from one of the stopping sections, the transverse sections substantially covering side walls of the plurality of first color filters.

24. The imaging device of claim 23, wherein at least one of the transverse sections extends at least partially between the first color filter and its adjacent color filter.

25. The imaging device of claim 23, wherein the transverse sections entirely cover side walls of each of the first color filters.

26. The imaging device of claim 23, wherein the stopping layer further comprises a plurality of lower sections each extending from one of the transverse sections and located below a second color filter.

27. The imaging device of claim 21, wherein the stopping layer is formed to be more resistant to a chemical mechanical planarization process than second color filters.

28. The imaging device of claim 21, wherein the stopping layer is formed of a material selected from the group consisting of an oxide material, a silicon nitride material, and a mixture thereof.

29. The imaging device of claim 21, wherein the stopping layer has a substantially uniform thickness throughout the color filter array.

30. The imaging device of claim 21, wherein said imaging device is coupled to a processor of a processing system.

31. An imaging device comprising:
a color filter array formed over a semiconductor structure and comprising red, green, and blue filters; and
a continuous stopping layer formed on the green color filters;
wherein the stopping layer continuously extends between each green color filter and its adjacent red and blue filters and below the red and blue filters.

32. The imaging device of claim 31, wherein the red and blue color filters collectively comprise a planarized surface level with the stopping layer.

33. The imaging device of claim 31, wherein the red, green, and blue filters are arranged according to a Bayer filter pattern.

34. The imaging device of claim 31, wherein the stopping layer has a substantially uniform thickness throughout the color filter array.

35. The imaging device of claim 31, wherein the stopping layer has a thickness of no less than 100 Angstroms.

36. The imaging device of claim 35, wherein the stopping layer has a thickness in the range from about 100 Angstroms to about 300 Angstroms.

37. The imaging device of claim 31, wherein the stopping layer is formed of a material that is more resistant to a chemical mechanical planarization process than a material used for the red and blue filters.

38. The imaging device of claim 37, wherein the stopping layer is formed of an oxide material.

39. An imaging system comprising:
a pixel array;
a color filter array formed over the pixel array and including a plurality of color filters for different colors;
a stopping layer formed on at least one first color filter and extending to cover one or more side walls of the first color filter; and
a circuit coupled to the pixel array for using pixel signals from the pixel array and converting the pixel signals to image data.

40. The imaging system of claim 39, wherein the color filter array comprises a planarized surface level with the stopping layer.

41. The imaging system of claim 39, wherein the stopping layer comprises:
a plurality of stopping sections formed on a plurality of first color filters; and
a plurality of transverse sections each extending transversely from one of the stopping sections, the transverse sections substantially covering side walls of the plurality of first color filters.

42. The imaging system of claim 41, wherein the stopping layer further comprises a plurality of lower sections each extending from one of the transverse sections and located below a second color filter.

43. The imaging system of claim 42, wherein the stopping layer is continuous.

44. An imaging system comprising:
a pixel array;
a color filter array formed over the pixel array and of a plurality of first and second color filters;
a stopping layer formed on the first color filters; and
a circuit coupled to the pixel array for using pixel signals from the pixel array and converting the pixel signals to image data;
wherein the color filter array comprises a planarized surface formed on the second color filters and level with the stopping layer.

45. The imaging system of claim 44, wherein the stopping layer extends to at least partially cover one or more side walls of the first color filters.

46. The imaging system of claim 44, wherein the stopping layer comprises:
a plurality of stopping sections formed on the first color filters; and
a plurality of transverse sections each extending transversely from the stopping sections and between a first color filter and an adjacent second color filter.

47. The imaging system of claim 46, wherein the stopping layer further comprises a plurality of lower sections extending from one of the transverse sections and located below a second color filter.

48. The imaging system of claim 47, wherein the stopping layer is continuous.

49. A method of forming a color filter array, the method comprising:
forming a plurality of first color filters over an underlying structure;
forming a stopping layer over the first color filters; and
forming additional color filters in the color filter array in areas not occupied by the first color filters.

50. The method of claim 49 further comprising forming a planarized surface on the color filter array, wherein the planarized surface is level with the stopping layer.

51. The method of claim 49, wherein the step of forming a stopping layer comprises forming a continuous layer substantially covering side walls of the first color filters.

52. The method of claim 49, wherein the stopping layer is formed to have a uniform thickness across the color filter array.

53. The method of claim 49, wherein the step of forming a stopping layer is carried out at a temperature of about 240° C. or less.

54. The method of claim 49, wherein the step of forming a stopping layer comprises:
forming a plurality of stopping sections on the first color filters; and
forming a plurality of transverse sections each extending transversely from one of the stopping sections and at least partially covering a side wall of one of the first color filters.

55. The method of claim 54, wherein the transverse sections have a lesser lateral thickness than the thickness of the stopping sections.

56. The method of claim 54, wherein the step of forming a stopping layer comprises forming a plurality of lower sections each continuously extending from one of the transverse sections and being located under an additional color filter.

57. The method of claim 49, wherein the step of forming the additional color filters comprises providing one or more additional filter material layers and planarizing the additional filter material layers by a planarization process.

58. The method of claim 57, wherein the stopping layer is used to stop the planarization process.

59. The method of claim 57, wherein the planarization process is a chemical mechanical planarization process.

60. A method of forming an imaging device comprising a color filter array including red, green, and blue filters, the method comprising:
providing a semiconductor structure comprising a pixel array;
forming a plurality of green filters over the semiconductor structure;
forming a continuous stopping layer on the green filters; and
forming red and blue filters in the color filter array over the stopping layer.

61. The method of claim 60, wherein the step of forming red and blue filters comprises using a chemical mechanical planarization process.

62. The method of claim 60, wherein the step of forming red and blue filters comprises depositing a blue filter material layer over the stopping layer and planarizing the blue filter material layer to form blue filters.

63. The method of claim 62 further comprising selectively etching the blue filter material layer to remove blue filter material occupying areas of the red filters.

64. The method of claim 63, wherein the step of forming red and blue filters further comprises depositing a red filter material layer over the stopping layer and planarizing the red filter material layer to form red filters.

65. A method of forming an imaging device comprising a color filter array, the method comprising:
forming a pixel array;
forming a plurality of first color filters over the pixel array;
forming a stopping layer on the first color filters;
providing an additional color filter material layer between the first color filters; and
planarizing the additional color filter material layer to form additional color filters.

66. The method of claim 65, wherein the color filter array has a planarized surface level with the stopping layer.

67. The method of claim 65 further comprising forming a microlens array directly on the planarized surface of the color filter array.

68. The method of claim 65, wherein the step of forming a stopping layer comprises forming a continuous layer across the color filter array.

69. The method of claim 65, wherein the step of planarizing the additional color filter material layer comprises using a chemical mechanical planarization process to bring the additional color filter material layer to be level with the stopping layer.

70. The method of claim 69, wherein the stopping layer is used to stop the chemical mechanical planarization process.
